(19) United States
(12) Patent Application Publication
(10) Pub. No.: US 2012/0317539 A1
(43) Pub. Date: Dec. 13, 2012

(54) METHOD AND APPARATUS FOR OBTAINING WORKING INFORMATION IN SOFTWARE ENGINEERING

(75) Inventors: Ya Bin Dang, Beijing (CN); Ying Liu, Beijing (CN); HuaFang Tan, Beijing (CN)

(73) Assignee: International Business Machines Corporation, Armonk, NY (US)

(21) Appl. No.: 13/590,705

(22) Filed: Aug. 21, 2012

Related U.S. Application Data
(63) Continuation of application No. 13/358,697, filed on Jan. 26, 2012.

(30) Foreign Application Priority Data
Jan. 31, 2011 (CN) 201110033727.6

(51) Int. Cl. G06F 9/44

(52) U.S. Cl. 717/101

(57) ABSTRACT

A method for obtaining working information in software engineering is provided. The method includes generating a sensor for a software tool used in software engineering according to data storage manner of the software tool, where the sensor detects artifact change events associated with the software tool; and collecting the artifact change events from the sensor and analyzing at least one attribute of the artifact change events to obtain the working information. Also provided is an article of manufacture for carrying out the method for obtaining working information in software engineering as described in this application.

### CROSS-REFERENCE TO RELATED APPLICATION

This application is a continuation of and claims priority from U.S. patent application Ser. No. 13/358,697, filed Jan. 26, 2012, which in turn claims priority claims priority under 35 U.S.C. §119 from Chinese Patent Application No. 201110033727.6 filed Jan. 31, 2011, the entire contents of both are incorporated herein by reference.

### BACKGROUND OF THE INVENTION

1. Field of the Invention

The present invention relates to software engineering, more particularly, to a method and apparatus for obtaining working information in software engineering.

2. Description of Related Art

In the field of software engineering, a software project is usually completed by many members in a project team collaboratively. In this procedure, the leader of the project team assigns work and task to each member, and specifies the corresponding software tool. Each member completes the task assigned to him using his designated software tool, and thereby plays different roles in the team, such as a requirement analyst, an architect, a developer, a tester. During the process of collaboratively implementing a software project, every member in the team works in an interrelated way, for example, the architects build functional frames based on the synthesis and analysis on customer requirements made by requirement analysts, the developers perform particular developmental work based on such functional frames, and the testers test the software modules thus developed. Therefore, the collaboration and cooperation among members in a team is very important.

In order that team members can collaborate effectively, it is necessary to analyze and obtain various kinds of working information in software engineering, and share the working information with the members. The working information can include distribution and alteration of responsibilities, current product status, product-updating events, and the like. Generally, the working information can be reflected by artifacts and the status alteration thereof in a software project.

An artifact in a software project means all kinds of products produced in the process of software development, such as software models, source codes, test cases. Whenever a team member makes progress in his work, the produced artifact will change accordingly, thereby reflecting his work progress.

In the prior art, there has been some tools which can be useful in team communication and update notification. Some tools, such as RSS, have the function of notification, and can serve as a channel for notification among team members. Such a tool, however, cannot capture change events that occur in the software tool, and requires users to manually define which notifications should be sent to which team members. Some tools have the function of releasing messages, such as Facebook® and LinkedIn®, which allow every team member to release all kinds of information to the entire team. Releasing messages in such a way is similar to a broadcasting system within the team, where each member can receive the released messages, no matter whether he needs the messages or not. Besides, the releaser should manually define the released content as well. Some other tools have the function of version management, such as Microsoft® Team Foundation Server and CVS/SVN, which can capture change events that occur on the artifacts under supervision, and can send the change events to related members if necessary. Such tools, however, are designed for specific management objectives or artifacts. If the management objectives change, the extension of the tools is not an easy thing.

In the case that every member in a project team utilizes different software tools to update different kinds of artifacts, none of the tools in the prior art as described above can universally perform detection on different software tools and artifacts, or automatically obtain the working information relating to team members' work progress and make it transmitted and communicated among team members. Therefore, a solution is expected which, for different work contents in a team, can automatically detect the status change of artifacts, thereby obtaining useful working information, and improving the cooperativeness and work efficiency of the team.

### SUMMARY OF THE INVENTION

The present invention provides a method and apparatus for obtaining working information in software engineering and improving the efficiency of software development.

One aspect of the present invention provides an apparatus for obtaining working information in software engineering, including: a sensor generator configured to generate a sensor for a software tool used in software engineering according to data storage manner of the software tool, where the sensor detects artifact change events associated with the software tool; and a central analyzer configured to collect the artifact change events from the sensor and analyze at least one attribute of the artifact change events to obtain the working information.

Another aspect of the present invention provides a method for obtaining working information in software engineering, the method including the steps of: generating a sensor for a software tool used in software engineering according to data storage manner of the software tool, where the sensor detects artifact change events associated with the software tool; and collecting the artifact change events from the sensor and analyze at least one attribute of the artifact change events to obtain the working information.

Another aspect of the present invention provides a computer readable article of manufacture tangibly embodying non-transitory computer readable instructions which, when executed, cause a computer to carry out the steps of a method for obtaining working information in software engineering, the method including the steps of: generating a sensor for a software tool used in software engineering according to data storage manner of the software tool, where the sensor detects artifact change events associated with the software tool; and collecting the artifact change events from the sensor and analyze at least one attribute of the artifact change events to obtain the working information.

By using the apparatus and method in the embodiments of the invention, it can generate on the spot suitable sensors for different software tools, thereby detecting the artifact change events associated with the software tool, and, based on the detected artifact change events, obtain all kinds of required working information, thereby improving cooperation of the team and efficiency of the project.

### BRIEF DESCRIPTION OF THE DRAWINGS

In order to describe features and benefits of the embodiment of the invention in detail, the following drawings will be referred to. Where possible, same or similar reference number will be used in drawings and description to denote same or similar part, in which:

FIG. 1 is a block diagram showing an apparatus for obtaining working information according to an embodiment of the invention.

FIG. 2 shows the structure of a sensor generator and the generated sensor according to an embodiment of the invention.

FIG. 3 shows an example of a responsibility matrix.

FIG. 4 shows several exemplary implementing modes of an apparatus 10 according to embodiments of the invention.

FIG. 5 is a flow chart showing a method for obtaining working information according to an embodiment of the invention.

FIG. 6 shows the substeps of step 52 in FIG. 5.

### DETAILED DESCRIPTION OF THE PREFERRED EMBODIMENTS

Next, detailed examples of the invention will be described in conjunction with the drawings. It should be appreciated that the description of the following detailed examples are merely to explain the exemplary implementing modes, rather than to impose any limitation on scope of the invention.

In a plurality of examples of the invention, for different software tools used by team members, corresponding sensors are generated and subsequently used to detect the status change of artifacts in a software project, thereby obtaining desired working information based on the change of artifacts.

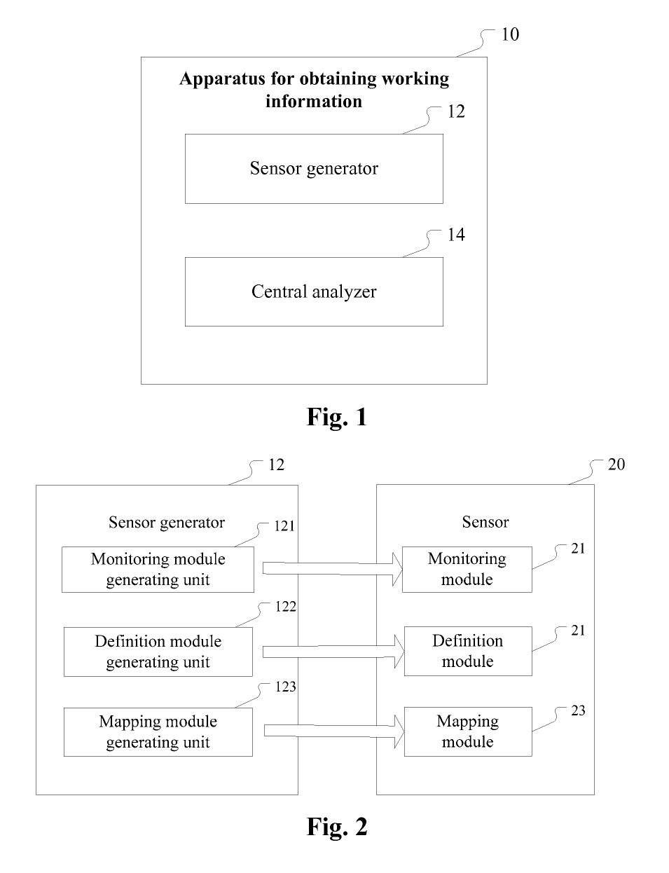

FIG. 1 is a block diagram showing an apparatus for obtaining working information according to an embodiment of the invention. As shown in the figure, the apparatus 10 includes a sensor generator 12 and a central analyzer 14. The sensor generator 12 is configured to generate a sensor for a software tool used in software engineering according to the data storage manner of the software tool, such that the sensor detects the artifact change events associated with the software tool. The central analyzer 14 is configured to collect the artifact change events from the sensor, and analyze at least one attribute of the artifact change events, thereby obtaining working information.

In particular, the sensor generator 12 is configured to generate special sensors for different types of software tools, such that the sensors can detect the change of artifacts by capturing the operation of software tool. However, in the prior art, there are thousands of software tools with different usage and functions, and in future, there can be more software tools with more complex functions. Because of the large number of software tools, it is impossible to generate tool-specific sensors by studying the operating modes and functions of the tools one by one. Therefore, the sensor generator 12 according to embodiments of the invention classifies software tools based on their data storage manner, and generates corresponding sensors based on the classification. In addition, the sensor generator 12 allows the generated sensor to be able to detect artifact change events according to the definition by users.

In order that the generated sensor can implement the above function, in one example, the sensor generator 12 and the generated sensor have the structures shown in FIG. 2. As shown in FIG. 2, the generated sensor 20 can include a monitoring module 21, used to monitor and capture the operation of software tools, where the operation can be any action caused by software tools and resulting in the change of artifacts, such as creating/editing/deleting a data file, inserting/updating/deleting a data item, and the like; a definition module 22, used to obtain the mapping relationship between the operation of software tools and the change of artifacts; and a mapping module 23, used to map the operation of software tools to the change events of artifacts according to the mapping relationship. Correspondingly, in order to generate the sensor 20 as described above, the sensor generator 12 can functionally include generating units for the modules described above, i.e. a monitoring module generating unit 121, a definition module generating unit 122 and a mapping module generating unit 123. Next, the working mode and the generating procedure of each module of the sensor 20 will be described.

The monitoring module 21 is configured to monitor and capture the operation of software tools. As different software tools have different data manipulation modes, the implementing modes of the monitoring module generating unit 121 and the generating procedure of the monitoring module 21 differ for various software tools accordingly.

In spite of the large number of software tools, they can be classified, based on the data storage manner, into three types: software tools based on files, software tools based on databases, and software tools based on services.

Software tools based on files manipulate data in the form of files. That is, they read data from files, manipulate and process the data, and write the processed data into local files as well. Such software tools include Microsoft® Word, Gantt Project, and the like. For software tools based on files, the creation or edit of any data can be reflected by the change of files.

Software tools based on databases manipulate data in the form of databases. That is, they read datasheets from databases, and write the processing results into databases. Such software tools include RTC, Doors®, RQM, and the like. For software tools based on databases, the creation or edit of data can be reflected by the change of databases, for example, the insertion, update, or deletion of datasheets.

Software tools based on services manipulate data through remote applications/services. For such software tools, the creation or edit of data can be reflected by calling remote applications/services.

For the three types of software tools, the monitoring module generating unit 121 generates different monitoring modules 21 according to the data storage manner of the tools.

In particular, for a software tool based on files, the monitoring module generating unit 121 can add an application in the operating system where the software tool is installed, such that the application monitors the change of one or more local files associated with the software tool, or alternatively, the application monitors the reading and writing operation to local files performed by the software tool. For example, the monitoring module generating unit 121 can create and start a background process in the operating system, which process monitors changes of files by using the input/output interface of the file system provided by the operating system. Such an application, which monitors the I/O of a software tool, can serve as a monitoring module 21 for a software tool based on files.

For a software tool based on databases, the monitoring module generating unit 121 can add a wrapper in the database driver, for example, it can provide a set of interfaces matched with the original database driver, monitor the interfaces, and transfer the interface invoking by the software tool, in an unchanged way, to the original database driver, such that the wrapper can monitor the data manipulation on the database. In particular, for many databases, JDBC (Java Data Base Connectivity) can be used as API (Application Program Interface) to execute SQL statements, thereby providing the uniform access and operation for different databases. By adding a wrapper program in the JDBC driver, the API can execute the SQL statements and, at the same time, monitor and record the sequence of SQL operation. Thus, the added wrapper can serve as the monitoring module 21 to monitor and capture the operation on the database.

For a software tool based on services, the monitoring module generating unit 121 can add a wrapper in the service invocation layer of the software tool. For example, by obtaining messages in the network layer via the Socket layer interface of the operating system, and monitoring the service invocation of interest, the wrapper can be made to monitor and record the invoking instructions to remote service made by the software tool. Thus, the added wrapper can serve as a monitoring module 21 for a software tool based on services for capturing the data manipulation of the software tool.

As described above, for all kinds of software tools, the monitoring module generating unit 121 can create appropriate monitoring modules 21 based on the data storage manner of the tools, such that the monitoring modules 21 can monitor and capture the operation of the software tools.

However, all the operating information captured by the monitoring modules 21 generated according to the above procedures is operations on the “atomic layer”, i.e. detailed operating instructions, for example, writing instructions for a local file, a sequence of SQL statements for a database, and the like. Generally speaking, most users merely perform the upper layer operations on software tools, and cannot understand the primitively captured underlying instructions, or to obtain the artifact change information associated with the software tools. Therefore, such primitively captured operations are generally unreadable to users. In order to acquire information that is understandable to users, it is necessary to convert the captured instructions into artifact change events associated with the software tools, which are understandable to users.

In order to perform the converting process, reference has to be made to the relationship between the operations of software tools and the changes of the related artifacts. However, it can be understood that the relationship depends on particular software tools, and therefore is different for different software tools. In order that the generated sensor 20 is universally applicable to different types of software tools, the sensor generator 12 includes a definition module generating unit 122 to generate a definition module 22 for the sensor, where the definition module 22 is configured to receive definition from users, thereby obtaining the relationship between the operations of software tools and the changes of artifacts.

In particular, in one example, the definition module 22 is an interface of the sensor 20 to receive the definition on the mapping relationship made by users. In a representative example, the definition module 22 can provide several options for users, such as record or name. Therefore, if a user feels that a certain operation is worth recording, by using the options mentioned above, he can instruct, while or after performing the operation, the definition module 22 to record the operation. That is, to record the instruction sequence captured when the operation is performed. Furthermore, a user can give a meaningful name to the operation and the underlying instruction sequence to indicate the status change of the artifact corresponding to the operation. For example, when an architect adds a functional module to a software project, he can instruct the definition module 22 to record the operating instruction sequence during the process of addition, and name the recorded instruction sequence as “create a new functional module”. Accordingly, under the instructions of the user, the definition module 22 records the instruction sequence and the corresponding name, thereby establishing the mapping relationship between the instruction sequence and the name. As the names generally reflect changes of artifacts, it can be deemed that the definition module 22 establishes the mapping relationship between the operations of software tools and the change events of artifacts. For example, an artifact change event (for example, an architect creates a new functional module) can be mapped into a set of database operations, including the SQL instruction sequence on one or more datasheets. In one example, the definition module 22 stores the definitions of the above mentioned mapping relationship in a mapping table. Table 1 below shows a detailed example of the mapping table maintained by the definition module 22.

TABLE 1
the mapping table of operations of software tools and
change events of artifacts

| Change | Instruction sequence corresponding to operations | |
|---|---|---|
| events of artifacts | of the tools | |
| Create a new | 1. instruction: insert | Target: module table |
| functional module | 2. instruction: update | Target: system design table |
| | 3. instruction: update | Target: release table |
| Modify an existing | . . . | . . . |
| functional module | | |

Based on the mapping table maintained by the definition module 22, it is possible to annotate and read the captured operations. In particular, the sensor generator 12 can include a mapping module generating unit 123, used to generate a mapping module 23 for the sensor, where the mapping module 23 is configured to map the operations captured by the monitoring module 21 to change events of artifacts according to the mapping relationship maintained by the definition module 22. In a particular embodiment, for an instruction sequence captured by the monitoring module 21, the mapping module 23 searches and matches it in the mapping table maintained by the definition module 22. Once the mapping module finds a matched instruction sequence, it looks up the artifact change events corresponding to the instruction sequence in the mapping table, thereby obtaining and reporting the corresponding artifact change events. Thus, by referring to the mapping table, the mapping module 23 converts the captured underlying instruction sequence into user-readable artifact change events. In addition, since the mapping table is manually defined as needed by users via the definition module 22, the mapping module 23 can merely map and report the operations specified by a user, and thus merely monitor the artifact change events which the user is interested in.

As described above, the sensor generator 12 can generate suitable sensors 20 for different software tools, and enable the sensor 20 to detect the artifact change events associated with the software tools according to the definition of users. Based on the artifact change events detected by the sensor 20, the apparatus 10 according to embodiments of the invention uses a central analyzer 14 to analyze the obtained artifact change events and the attributes thereof, thus obtaining working information. The attributes mentioned above can include the sending time of the artifact change events, the name of the associated software tool, the user of the software tool, the role played by the user, and the like.

In one embodiment, the working information includes the working events in various working aspects. In particular, in some examples, the artifact change event per se detected by a single sensor can be used to represent a working event, such as updating the design architecture or creating a new test case. In this case, the central analyzer 14 collects the artifact change events from the sensor 20 of the software tool, and analyzes the attributes of the artifact change events, such as the sending time of the artifact change events, the name of the software tool, the user, the role played by the user, and the like. The central analyzer 14 can selectively analyze one or more attributes described above as needed, and combine the attribute(s) with the artifact change events, thereby providing working events, such as “Tom, the architect, updated the design architecture at 8:00 am, Jan 1”, as the working information.

In some examples, a working event is represented jointly by operations of a plurality of software tools. In this case, the central analyzer 14 can include a setting unit (not shown), which is, similar to the definition module 22 in the generated sensor 20, configured to receive setting from users, thereby maintaining a mapping table. The difference is that, the mapping table maintained by the definition module 22 is used to record the mapping relationship between the underlying operating instructions and the artifact change events, while the mapping table maintained by the setting unit in the central analyzer 14 can record the relationship between the artifact event sequence, consisting of a plurality of artifact change events and the related attributes thereof, and the more upper layer working event. For example, in one particular example, it can be set that the artifact event sequence, consisting of an artifact change event from a tester “finding a problem with the test case 1”, an artifact change event from a developer “modifying the program” and an artifact change event from the tester “the test case 1 passed the test”, is mapped to a working event “removing an error”. Accordingly, after collecting a set of artifact change events, the central analyzer 14 can analyze the role attributes of these events, compare the combination of the events and the roles with the artifact event sequences listed in the mapping table, and perform the mapping process if matched, thereby obtaining working events based on a plurality of artifact change events and the attributes thereof.

In one embodiment, the working information also includes the evaluation and analysis on the project team based on the collected artifact change events and the attributes thereof.

In one particular example, the working information includes the evaluation on the efficiency of team work. In order to evaluate the collaboration of a team, the central analyzer 14 collects the detected artifact change events from the sensors of software tools used by team members, and analyzes and records the sending time and the role of the user for each artifact change event. By analyzing the feedback time of some roles to specific artifact change events, that is, by analyzing the intervals of sending time of a specific artifact change event from a role and another specific artifact change event from another role, it can evaluate the efficiency of collaboration of the team. For example, if, after receiving the artifact change event “changing the design architecture” from the sensor of an architect, it receives an feedback event, such as modifying the program from a developer in a very short period of time, the efficiency of team work can be deemed high.

In one particular example, the working information includes the evaluation on the productivity of a team. To that end, the central analyzer 14 collects artifact change events from the sensors of team members, and records the sending time of each event. If the intervals of sending time of the events are relatively short, or, if a relatively large number of artifact change events are collected in a predetermined period of time, it can be deemed that the entire team is proactive and has high productivity.

In another particular example, the working information includes the risk prediction of the team work. Generally, in order to complete a software project, the work that every member is assigned is interrelated and in a certain order. For example, after the analyst changes the customer requirements, the architect edits the architecture design, the developer implements the detailed functions based on the architecture design, and then the tester performs a testing process. Therefore, the central analyzer 14 can preset a standard sequence of artifact change events and the related roles, and if the actually detected artifact change events and the role attributes thereof miss one or more steps compared with the standard sequence, it can be deemed that there is a risk in the quality of the software project.

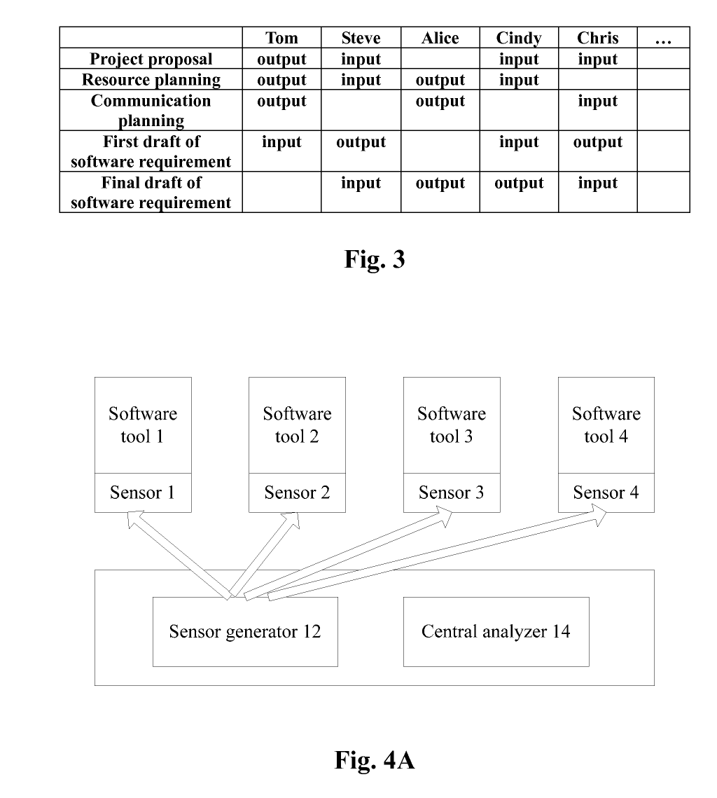

In one embodiment, the central analyzer 14 also transmits and shares the obtained working information among the team members. In some existing management tools for software projects, the responsibility matrix has been used to record the assignment of responsibility among team members. More particularly, the responsibility matrix usually records the input/output flow of each artifact among team members, and thus records the handover of work among members. FIG. 3 shows an example of the responsibility matrix. As shown in FIG. 3, the matrix table shows in its first column various artifacts involved in the development of the software project, and in its first row the members of the team. The matrix table uses input or output to indicate the relevancy between the members and particular artifacts. For example, the matrix table shows in its second row that the member Tom should output the project proposal, while the members Steve, Cindy and Chris should input the project proposal. This means that Tom should transfer the project proposal to Steve, Cindy and Chris. Such a responsibility matrix can show the transmission of artifacts between team members. Therefore, the central analyzer 14 can transmit and share the obtained working information among team members by referring to the responsibility matrix. In particular, when analyzing and obtaining the working information, the central analyzer 14 can record the artifacts associated with the working information. Subsequently, by referring to the responsibility matrix, the central analyzer 14 acquires the flow of the artifact among members, thereby transferring the working information to the members who should obtain the artifact. Thus, it can avoid the unnecessary transmission of some targeted working information among unrelated members. In one example, by referring to the responsibility matrix, the central analyzer 14 can also issue task reminders to the members who have obtained the working information. In one example, the central analyzer 14 can dynamically modify the responsibility matrix according to the feedback of members to the working information.

It can be understood that although several examples of the working information are given above, however, the working information can include more kinds of information relating to the artifact status or the artifact change events. Depending on the need and preset of the administrator of a software project, the central analyzer 14 can obtain more kinds of working information based on the artifact change events and the attributes thereof collected from the sensor.

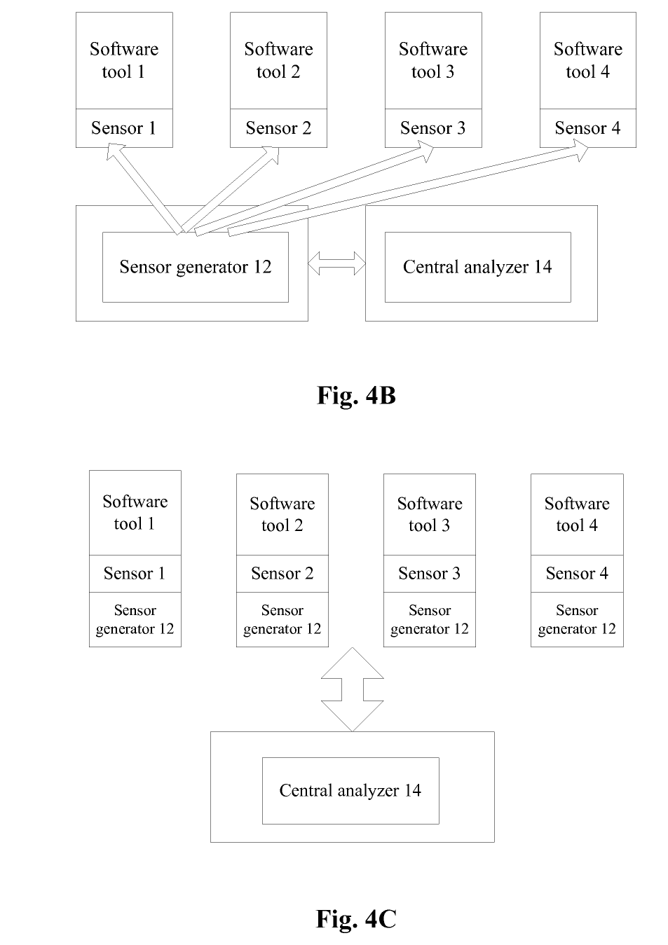

As for the implementation of the apparatus 10 for obtaining working information, the sensor generator 12 and the central analyzer 14 can have many implementing modes. FIG. 4 shows several exemplary implementing modes of the apparatus 10 according to embodiments of the invention. As shown in FIG. 4A, in one example, the sensor generator 12 and the central analyzer 14 locate on the same physical platform, and the physical platform is independent from the physical platform resident by the software tools of the members. When generating sensors, the sensor generator 12 remotely loads the codes of the sensor modules into the software tools, thereby creating sensors for various software tools. The generated sensors detect the artifact change events and transfer them to the central analyzer 14 for further analysis, thereby obtaining working information. In another example, as shown in FIG. 4B, the sensor generator 12 and the central analyzer 14 can locate on different physical platforms, and each of the platforms is independent from the physical platform resident by the software tools. In this case, the sensor generator 12 remotely generates sensors for software tools as well, and remotely communicates with the central analyzer 14. In yet another example, as shown in FIG. 4C, the sensor generators 12 are arranged on the physical platforms resident by various software tools, while the central analyzer 14 locates on an independent physical platform. Thus, the sensor generators 12 can locally generate and install the corresponding sensors for software tools. The sensor generators 12 and the central analyzer 14 can remotely communicate with each other. The remote communication mentioned above can be conducted by using various wired or wireless methods known in the art or possibly employed in future.

The apparatus 10 of the invention can generate appropriate sensors for members of a project team, and enable the sensors to detect the artifact change events associated with the software tools used by the members, thereby obtaining working information based on the artifact change events of the members.

Based on the same inventive concept, the present invention also provides a method for obtaining working information corresponding to the apparatus described above.

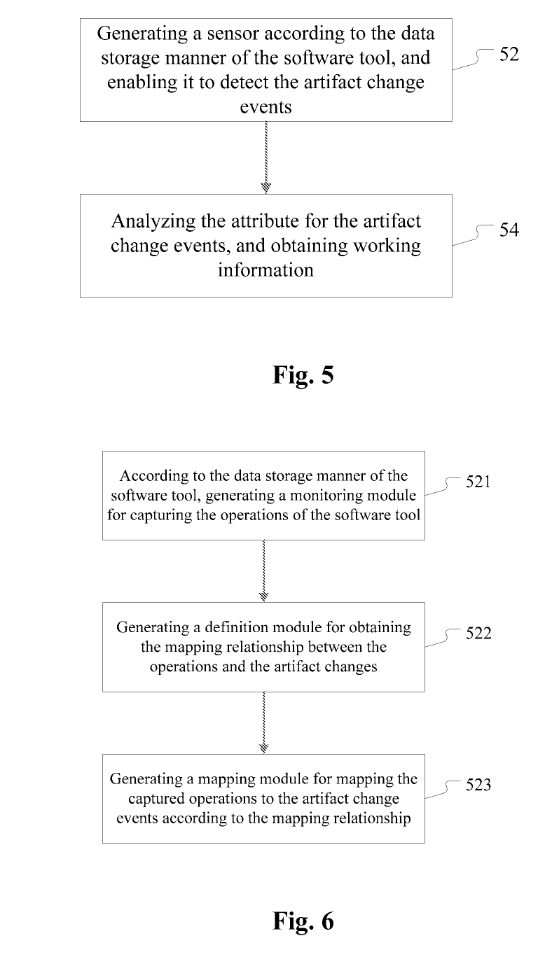

FIG. 5 is a flow chart showing a method for obtaining working information according to an embodiment of the invention. As shown in the figure, the method includes: step 52, generating a sensor for a software tool used in software engineering according to the data storage manner of the software tool, such that the sensor detects the artifact change events associated with the software tool; and step 54, collecting the artifact change events from the sensor, and analyzing at least one attribute of the artifact change events, thereby obtaining working information.

In particular, in order that the sensor generated in step 52 can be suitable for different software tools, in one example, step 52 can include the substeps shown in FIG. 6. As shown in FIG. 6, the substeps include: step 521, generating a monitoring module according to the data storage manner of the software tool, for monitoring and capturing the operations of the software tool; step 522, generating a definition module, for obtaining the mapping relationship between the operations and the artifact changes; and step 523, generating a mapping module, for mapping the operations of the software tool to the artifact change events according to said mapping relationship.

In order that the monitoring module generated in step 521 can capture the operations of various software tools, it is necessary to refer to the data manipulation manner of various software tools. In particular, for a software tool based on files, in step 521, it can add an application in the operating system where the software tool is installed, such that the application monitors the I/O of the software tool on local files, thereby functioning as a monitoring module.

For a software tool based on databases, in step 521, it can add a wrapper in the database driver, and allow it to monitor the data manipulation on the database, thereby functioning as a monitoring module.

For a software tool based on services, in step 521, it can add a wrapper in the service invocation layer of the software tool, and allow it to monitor and record the invoking instructions to remote service made by the software tool, thereby functioning as a monitoring module.

After capturing the operations of the software tool by generating a monitoring module, it is advantageous to convert the captured operations to user-readable artifact change events. To that end, in step 521, a definition module is generated to receive the definition on artifact change events by users. In particular, an interface can be created for obtaining the mapping relationship defined by users between the underlying operations and the artifact change events. The definition module can also store the definition of the mapping relationship described above by maintaining a mapping table.

Depending on the mapping table maintained by the definition module, it is possible to annotate and read the captured operations. Therefore, in step 522, a mapping module is generated, and is configured to map the operations captured by the monitoring module to change events of artifacts by referring to the mapping table maintained by the definition module.

As described above, in step 52, suitable sensors can be generated for different software tools, thereby detecting the artifact change events associated with the software tools. Based on the detected artifact change events, it can in step 53 analyze the obtained artifact change events and the attributes thereof, and thus obtain working information. The attributes mentioned above can include the sending time of the artifact change events, the name of the associated software tool, the user, the role played by the user, and the like.

In one example, the working information includes various working events. A working event can be represented by a single artifact change event and the attributes thereof, or be represented jointly by a plurality of artifact change events from a plurality of software tools and the attributes thereof. In one example, the working information also includes the evaluation and analysis on a team based on the collected artifact change events and the attributes thereof, for example, the evaluation on collaboration of a team, the evaluation on the productivity of a team, the risk prediction of the team work, and the like.

In one example, the method according to embodiments of the invention also includes transmitting and sharing the obtained working information among the team members. In particular, by referring to a responsibility matrix, it acquires the flow of the artifact among members, thereby transferring the working information to the members who should obtain the artifact. In one example, it can dynamically modify the responsibility matrix according to the feedback of members to the working information.

Thus, by using the method described above, it is possible to generate suitable sensors for various software tools, and thus detect the status changes of the artifacts, thereby obtaining the desired working information.

Those skilled in the art can understand that the above-mentioned method and apparatus for obtaining working information can be practiced by executable instructions and/or controlling codes in the processors e.g. codes in mediums like disc, CD or DVD-ROM; memories like ROM or EPROM; and carriers like optical or electronic signal carrier. The apparatus and its units can be realized using hardware like VLSI or Gates and Arrays, like semiconductors e.g. Logic Chip, transistors, or like programmable hardware equipments for example FPGA, programmable logic equipments; or using software executed by different kinds of processors; or using the integration of said hardware and software. The application for implementing the invention can be programmed using object-oriented languages like Java or Smalltalk, C++, and the traditional procedural languages like C language or other similar languages. The source code can be executed locally or remotely.

The above-described exemplary embodiments are intended to be illustrative in all respects of the method and apparatus for obtaining working information, rather than restrictive, of the present invention. Those skilled in the art should recognize that the present invention is capable of many variations and modifications within the scope and spirit of the present invention. The scope of the present invention is defined only by the appended claims.

1. A method for obtaining working information in software engineering, the method comprising the steps of:
generating a sensor for a software tool used in software engineering according to data storage manner of the software tool, wherein the sensor detects artifact change events associated with the software tool; and
collecting the artifact change events from the sensor and analyzing at least one attribute of the artifact change events to obtain the working information.

2. The method according to claim 1, wherein said generating a sensor comprises:
generating a monitoring module according to the data storage manner of the software tool, wherein the generating module is configured to capture operations of the software tool;
generating a definition module which is configured to obtain a mapping relationship between the operations and the artifact change events; and
generating a mapping module which is configured to map the operations captured by the monitoring module to the artifact change events according to said mapping relationship.

3. The method according to claim 2, wherein said generating a monitoring module comprises (i) generating an application for monitoring a reading and writing of the software tool on local files when the software tool is based on files, (ii) adding a wrapper in a database driver and enabling it to monitor data manipulation on a database when the software tool is based on databases, and (iii) adding a wrapper in a service invocation layer of the software tool and enabling it to monitor the invoking instructions to a remote service when the software tool is based on services.

4. The method according to claim 2, wherein the definition module is configured to maintain a mapping table which is used to record the mapping relationship between the captured operations and the artifact change events.

5. The method according to claim 1, wherein said at least one attribute comprises at least one attribute selected from a group consisting of a sending time of the artifact change events, a name of the associated software tool, a user of the software tool, and a role played by the user.

6. The method according to claim 1, wherein the working information comprises a working event, and the working event is based on a single artifact change event, or on a plurality of artifact change events from the sensors of a plurality of the software tools.

7. The method according to claim 1, further comprising transmitting and sharing the working information among members involved in the software engineering by referring to a responsibility matrix.

8. The method according to claim 7, further comprising dynamically modifying the responsibility matrix according to feedback from members of the working information.

9. A non-transitory computer readable article of manufacture tangibly embodying computer readable instructions which, when executed, cause a computer to carry out the steps of a method for obtaining working information in software engineering, the method comprising the steps of:
generating a sensor for a software tool used in software engineering according to data storage manner of the software tool, wherein the sensor detects artifact change events associated with the software tool; and
collecting the artifact change events from the sensor and analyzing at least one attribute of the artifact change events to obtain the working information.
